(19) United States
(12) Patent Application Publication
(10) Pub. No.: US 2026/0221144 A1
(43) Pub. Date: Jul. 30, 2026

(54) METHOD AND DEVICE FOR FLEXIBLE COMBINED FORMAT BIT-RATE ADAPTATION IN AN AUDIO CODEC

(71) Applicant: VOICEAGE CORPORATION, Town of Mount Royal (CA)

(72) Inventor: Vaclav EKSLER, Brno (CZ)

(21) Appl. No.: 19/145,718

(22) PCT Filed: Jan. 22, 2024
(86) PCT No.: PCT/CA2024/050067

§ 371 Date: Jul. 3, 2025

Related U.S. Application Data
(60) Provisional application No. 63/480,845, filed on Jan. 20, 2023.

(51) Int. Cl. G10L 19/008; H04S 7/00

(52) U.S. Cl. CPC G10L 19/008; H04S 7/30

(57) ABSTRACT

A combined format method and encoder for encoding a first number of audio object channels in ISM format and a second number of MASA audio channels, using an ISM format encoder comprising a front pre-processor of the audio object channels to produce ISM pre-processing parameters and a core-encoder section responsive to an adapted ISM total bit-rate for coding the audio object channels. A MASA format encoder is responsive to an adapted MASA total bit-rate for coding the MASA channels. A device for combined format bit-rate adaptation uses at least one ISM pre-processing parameter for (a) adapting an initial ISM total bit-rate to produce the adapted ISM total bit-rate and (b) adapting an initial MASA total bit-rate to produce the adapted MASA total bit-rate. A corresponding combined format decoder is also proposed.

### TECHNICAL FIELD

The present disclosure relates to a combined format encoding method using combined format bit-rate adaptation, a combined format encoder comprising a device for combined format bit-rate adaptation, a combined format decoding method, and a combined format decoder.

In the present disclosure and the appended claims:
(a) The term “sound” may be related to speech, audio and any other sound.
(b) The term “multichannel” may be related to two or more channels.
(c) The term “stereo” is an abbreviation for “stereophonic”.
(d) The term “mono” is an abbreviation for “monophonic”.
(e) The term “object-based audio” is intended to represent an auditory scene as a collection of individual elements, also known as audio objects. Also, “object-based audio” may comprise, for example, speech, music and any other sound including general audio sound.
(f) The term “audio object” is intended to designate an audio stream with associated metadata. For example, in the present disclosure, an “audio object” is referred to as an independent audio stream with metadata (ISM).
(g) The term “audio stream” is intended to represent, in a bit-stream, an audio waveform, for example speech, music or any other sound including general audio sound, and may consist of one channel (mono) although multi-channels including two (stereo) or more channels might be also considered.
(h) The term “metadata” is intended to represent a set of information describing for example an audio stream and an artistic intension used to translate the original or coded audio objects to a reproduction system. The metadata usually describes spatial properties of each individual audio object, such as position, orientation, volume, width, etc.
(i) The term “audio format” is intended to designate an approach to achieve an immersive audio experience.
(j) The term “reproduction system” is intended to designate an element, in a decoder, capable of rendering audio objects, for example but not exclusively in a 3D (Three-Dimensional) audio space around a listener using the transmitted metadata and artistic intension at the reproduction side. The rendering can be performed to a target loudspeaker layout (e.g. 5.1 surround) or to headphones while the metadata can be dynamically modified, e.g. in response to a head-tracking device feedback. Other types of rendering may be contemplated.

### BACKGROUND

Historically, conversational telephony has been implemented with mono handsets having only one transducer to output sound only to one of the user's ears. In the last decade, users have started to use their portable handset in conjunction with a headphone to receive the sound over their two ears mainly to listen to music but also, sometimes, to listen to speech. Nevertheless, when a portable handset is used to transmit and receive conversational speech, the content is still mono but presented to the user's two ears when a headphone is used.

With the 3GPP (3rd Generation Partnership Project) speech coding standard, Codec for Enhanced Voice Services (EVS), as described in Reference [1], of which the full content is incorporated herein by reference, the quality of the coded sound, for example speech and/or audio that is transmitted and received through a portable handset has been significantly improved. The next natural step is to transmit stereo information such that the receiver gets as close as possible to a real-life audio scene that is captured at the other end of the communication link.

Further, in last years, the generation, recording, representation, coding, transmission, and reproduction of audio is moving towards enhanced, interactive and immersive experience for the listener. The immersive experience can be described, for example, as a state of being deeply engaged or involved in a sound scene while sounds are coming from all directions. In immersive audio (also called 3D (Three-Dimensional) audio), the sound image is reproduced in all three dimensions around the listener, taking into consideration a wide range of sound characteristics like timbre, directivity, reverberation, transparency and accuracy of (auditory) spaciousness. Immersive audio is produced for a particular sound playback or reproduction system such as loudspeaker-based-system, integrated reproduction system (sound bar) or headphones. Then, interactivity of a sound reproduction system may include, for example, an ability to adjust sound levels, change positions of sounds, or select different languages for the reproduction.

There are three fundamental approaches (also referred below as audio formats) to achieve an immersive audio (IA) experience.

A first IA approach is a channel-based audio where multiple spaced microphones are used to capture sounds from different directions while one microphone corresponds to one audio channel in a specific loudspeaker layout. Each recorded channel is supplied to a loudspeaker in a particular location. Examples of channel-based audio comprise, for example, stereo, 5.1 surround, 5.1+4 etc.

A second IA approach is a scene-based audio (SBA) which represents a desired sound field over a localized space as a function of time by a combination of dimensional components. The signals representing the scene-based audio are independent of the sound sources positions while the sound field has to be transformed to a chosen loudspeakers layout at the rendering reproduction system. An example of scene-based audio is ambisonics.

A third immersive audio (IA) approach is an object-based audio which represents an auditory scene as a set of individual audio elements (for example speaker, singer, drums, guitar) accompanied by information about, for example their position in the audio scene, so that they can be rendered at the reproduction system to their intended locations. This gives an object-based audio a great flexibility and interactivity because each object is kept discrete and can be individually manipulated. An example of object-coding system is described e.g. in Reference [3], of which the full content is incorporated herein by reference.

Beyond the three above discussed fundamental approaches, new multi-channel IA coding techniques are being developed such as Metadata-Assisted Spatial Audio (MASA) as described for example in Reference [4], of which the full content is incorporated herein by reference. In the MASA approach, the MASA metadata (e.g. direction, energy ratio, spread coherence, distance, surround coherence, all in several time-frequency slots) are generated in a MASA analyzer, quantized, coded, and passed into the bit-stream while MASA audio channel(s) are treated as (multi-) mono or (multi-) stereo transport signals coded by core-encoder(s). At the MASA decoder, MASA metadata then guide the decoding and rendering process to recreate an output spatial sound.

Each of the above-described audio approaches to achieve an immersive experience presents pros and cons. It is thus common that, instead of only one audio approach, several audio approaches are combined in a complex audio system to create an immersive auditory scene. An example can be an audio system that combines scene-based audio (SBA) or MASA with object-based audio, for example SBA or MASA with a few discrete audio objects.

In recent years, 3GPP started working on developing a 3D sound codec for immersive services called IVAS (Immersive Voice and Audio Services) as described in Reference [2], of which the full content is incorporated herein by reference, based on the EVS codec as described in Reference [1]. The IVAS codec specifies several audio formats in which the audio scene is captured, transmitted, decoded and rendered. Namely, they are stereo format, object-based audio format, MC (Multi-Channel) audio format, SBA (Scene Based Audio) format, and MASA format.

Beyond coding of different audio formats, the IVAS codec can support a combination of audio formats. Advantages of such an approach comprise, for example, a single coding instance, lower memory demands, better coding efficiency than encoding audio formats separately, better control of the whole audio scene representation and reproduction, etc. One of the approaches to achieve this is to jointly capture the input format combination, e.g. to capture an object-based audio (e.g., voice) in combination with a spatial audio representation of the audio scene (e.g., ambience, or ambience with a dominant speaker or music instrument). The present disclosure will consider a combination of audio objects with MASA while other combinations like SBA with audio objects or stereo with audio objects could also be implemented. Similarly, a combination of more than two basic audio formats may also be implemented.

### SUMMARY

According to a first aspect, the present disclosure relates to a combined format method for encoding a number of first audio object channels in ISM format and a number of second audio channels in immersive audio (IA) format, comprising: ISM format encoding the audio object channels comprising: front pre-processing the audio object channels to produce ISM pre-processing parameters, and core-encoding the audio object channels in response to an adapted ISM total bit-rate; IA format encoding the second audio channels in response to an adapted IA total bit-rate; and a combined format bit-rate adaptation using at least one ISM pre-processing parameter from the front pre-processing of the audio object channels for (a) adapting an initial ISM total bit-rate to produce the adapted ISM total bit-rate and (b) adapting an initial IA total bit-rate to produce the adapted IA total bit-rate.

According to a second aspect, the present disclosure provides a combined format encoder for coding a number of first audio object channels in ISM format and a number of second audio channels in immersive audio (IA) format, comprising: an ISM format encoder comprising: a first front pre-processor of the audio object channels to produce ISM pre-processing parameters, and a first core-encoder section responsive to an adapted ISM total bit-rate for coding the audio object channels; an IA format encoder responsive to an adapted IA total bit-rate for coding the second audio channels; and a device for combined format bit-rate adaptation using at least one ISM pre-processing parameter from the first front pre-processor for (a) adapting an initial ISM total bit-rate to produce the adapted ISM total bit-rate and (b) adapting an initial IA total bit-rate to produce the adapted IA total bit-rate.

According to a third aspect, the present disclosure is concerned with a combined format method for decoding a number of first audio object channels in ISM format and a number of second audio channels in immersive audio (IA) format, comprising: receiving a bit-stream; decoding from the bit-stream information about a codec total bit-rate, information about the number of audio object channels, audio object channels coding information, second audio channels coding information, and information about an ISM importance class for each audio object channel; a combined format bit-rate adaptation using the number of audio objects channels, the codec total bit-rate, and the ISM importance class for each audio object channel for producing an adapted ISM total bit-rate and an adapted IA total bit-rate; core-decoding the audio object channels in response to the audio object channels coding information from the bit-stream, comprising configuring the ISM core-decoder in response to the adapted ISM total bit-rate; and core-decoding the second audio channels in response to the second audio channels coding information from the bit-stream, comprising configuring core-decoding of the second audio channels in response to the adapted IA total bit-rate.

According to a fourth aspect, there is provided a combined format decoder for decoding a number of first audio object channels in ISM format and a number of second audio channels in immersive audio (IA) format, comprising: a receiver of a bit-stream; a bit-stream decoder for decoding from the bit-stream information about a codec total bit-rate, information about the number of audio object channels, audio object channels coding information, second audio channels coding information, and information about an ISM importance class for each audio object channel; a device for combined format bit-rate adaptation using the number of audio objects channels, the codec total bit-rate, and the ISM importance class for each audio object channel for producing an adapted ISM total bit-rate and an adapted IA total bit-rate; an ISM core-decoder for decoding the audio object channels in response to the audio object channels coding information from the bit-stream and a configurator of the ISM core-decoder in response to the adapted ISM total bit-rate; and an IA core-decoder for decoding the second audio channels in response to the second audio channels coding information from the bit-stream and a configurator of the IA core-decoder in response to the adapted IA total bit-rate.

The foregoing and other objects, advantages and features of the combined format encoding method using combined format bit-rate adaptation, the combined format encoder comprising the device for combined format bit-rate adaptation, the combined format decoding method, and the combined format decoder will become more apparent upon reading of the following non-restrictive description of illustrative embodiments thereof, given by way of example only with reference to the accompanying drawings. In the different figures of the drawings, the same elements are identified by the same reference numerals.

### BRIEF DESCRIPTION OF THE DRAWINGS

In the appended drawings:

FIG. 1 is a schematic block diagram illustrating concurrently an example of combined format encoder and encoding method;

FIG. 2 is a schematic block diagram illustrating concurrently a combined format encoder using the device for combined format bit-rate adaptation according to the present disclosure and a corresponding combined format encoding method using combined format bit-rate adaptation according to the present disclosure;

FIG. 3 is graphical representation of an example of the impact of the combined format bit-rate adaptation on ism_total_brate and masa_total_brate bit-rates;

FIG. 4 is a schematic block diagram illustrating concurrently a combined format encoder using the device for combined format bit-rate adaptation according to the present disclosure and a corresponding combined format encoding method using combined format bit-rate adaptation according to the present disclosure, wherein the combined format bit-rate adaptation depends on parameters from the different formats encoder parts; and

FIG. 5 is a simplified block diagram of an example configuration of hardware components forming the combined format encoder comprising the device for combined format bit-rate adaptation, the corresponding combined format encoding method using combined format bit-rate adaptation, the combined format decoding method, and the combined format decoder.

### DETAILED DESCRIPTION

The combined format bit-rate adaptation in an audio codec will be described, by way of non-limitative example only, with reference to an IVAS coding framework referred to throughout the present disclosure as IVAS codec (or IVAS sound codec). However, it is within the scope of the present disclosure (a) to incorporate such technique of combined format bit-rate adaptation in any other sound codec supporting a combination of at least two audio formats and, also, (b) to use any immersive audio (IA) format other than MASA format.

### 1. INTRODUCTION

As a non-limitative example, the present disclosure considers a framework that supports simultaneous coding of
(a) several audio objects (for example up to 4 audio objects) including the audio streams with their associated metadata (ISM format). It should be noted that the metadata are not necessarily transmitted for at least some of the audio objects, for example in the case of non-diegetic content. Non-diegetic sounds in movies, TV shows and other videos are sounds that the characters cannot hear. Soundtracks are an example of non-diegetic sound, since the audience members are the only ones to hear the music; and
(b) MASA format with their associated metadata. The MASA metadata are provided to the input of the codec as they are generated by a user device or a MASA analyzer. The description of MASA metadata and the MASA analyzer can be found in Reference [5], of which the full content is incorporated herein by reference.

The coding of a combination of audio objects in ISM format and MASA format will be further referred to as Combined Objects-MASA (OMASA) format.

A codec such as the IVAS codec supports a simultaneous coding of several transport channels at a fixed total codec bit-rate ivas_total_brate. In IVAS, the total codec bit-rate is constant at several values between 13.2 kbps and 512 kbps. It should be noted that other constant values of total codec bit-rate as well as an adaptive total bit-rate can be considered without deviating from the scope of the present disclosure.

In case of coding a combination of audio formats in the IVAS framework, for example OMASA, the constant total codec bit-rate represents a sum of the MASA format bit-rate masa_total_brate, (i.e. the bit-rate to encode the MASA format part of OMASA channels) and the ISM total bit-rate ism_total_brate (i.e. the sum of bit-rates to encode all audio objects with their metadata related to ISM part of OMASA channels):

$$ivas\_total \_brate = masa\_total \_brate + ism\_total \_brate \qquad ( 1 )$$

In a basic and simple implementation, both the masa_total_brate bit-rate and the ism_total_brate bit-rate are constant at a given ivas_total_brate bit-rate and their actual values can be predefined e.g. in a ROM table. For example, in a scenario with 2 audio objects in OMASA format and with ivas_total_brate=96 kbps, the audio object channels can be coded at ism_total_brate=40 kbps while the masa_total_brate=56 kbps then. It should be pointed out that while the ism_total_brate bit-rate is constant, the bit-rates allocated to encode individual audio object channels (ISM audio channels) can be variable and based for example on the method described in Reference [3]. The bit-rates allocated to the individual audio object channels (ISM . . . , audio channels) 1, 2, . . . , N, are denoted as ism_brate(n), i.e. ism_brate(1), ism_brate(2), . . . , ism_brate(N) and they hold

$${\sum }_{n = 1}^{n = N} ism\_brate ( n ) = ism\_total \_brate \qquad ( 2 )$$

where N is the number of separately coded audio objects.

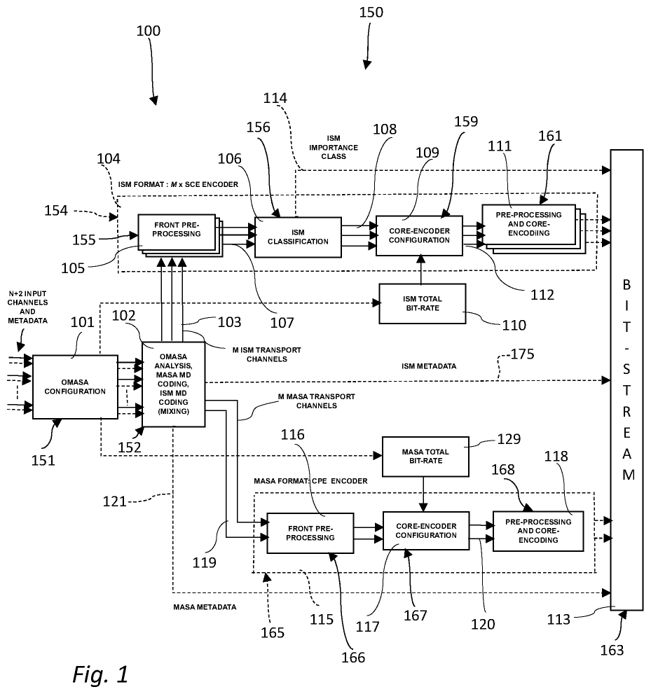

FIG. 1 is a schematic block diagram illustrating concurrently an example of combined format encoder 100 and encoding method 150.

The combined format encoder 100 uses combined format encoding with constant masa_total_brate and ism_total_brate bit-rates. In FIG. 1, N+2 input audio channels are considered where N is the number of input audio object channels (audio streams with metadata) and the additional two ‘+2’ channels correspond to input MASA audio channels (MASA audio streams with metadata). MASA usually encodes audio using one channel (mono-MASA) or two channels (stereo-MASA). Although for simplicity the present disclosure considers as a non-limitative embodiment stereo-MASA with two input audio channels, mono-MASA with one input audio channel could be implemented as well. Both the audio objects and MASA (as mentioned above) have their associated metadata and signaling. Also, both the audio objects and MASA are processed by frames (for example 20 ms long signal segments).

Referring to FIG. 1, the combined format encoder 100 comprises an OMASA configurator 101 performing an OMASA configuration operation 151 of the combined format encoding method 150. The configurator 101 configures the OMASA combined format by setting high-level parameters such as the number of transport channels, OMASA mode, and/or nominal (initial) masa_total_brate and nominal (initial) ism_total_brate bit-rates, where the OMASA mode is set depending on the ivas_total_brate bit-rate and the number of input audio object channels.

The combined format encoder 100 comprises an OMASA analyser and ISM/MASA metadata coder 102 performing an OMASA analysis and ISM/MASA metadata coding operation 152 of the combined format encoding method 150. The analyser/coder 102 (a) analyses the MASA audio channels and audio object channels with their respective metadata, (b) quantizes and codes the ISM metadata of the N audio object channels from the configurator 101, (c) quantizes and codes the MASA metadata, and (d) may possibly downmix at least a portion of the N+2 audio channels from the configurator 101; the analysis, coding, and down-mixing depends on the OMASA mode. The down-mixing is used usually at lower total codec bit-rates (ivas_total_brate) when the available bit-budget is too low to encode individually all the audio objects and MASA. In these cases, one, more, or even all the audio object channels are mixed with the MASA audio channels resulting in M+2 transport channels where M is the number of separately coded audio object channels and M≤N. The coded ISM metadata (line 175) and MASA metadata (line 121) are then directed to a bit-stream writer 113 performing a bit-stream writing operation 163 for transmission of the resulting bit-stream to a distant combined format decoder through a transmitter and communication channel (not shown).

Next, using the procedure as described in Reference [3], the M audio object channels 103 (audio streams without metadata) are analyzed and processed using an ISM format encoder 104 of the combined format encoder 100 performing an ISM format encoding operation 154 of the combined format encoding method 150. The ISM format encoder 104 comprises M single channel elements (SCE) where all the M audio object channels 103 are analyzed and processed in parallel in a front pre-processor 105 of the ISM format encoder 104 performing a front pre-processing operation 155 of the ISM format encoding operation 154. Although three (3) single channel elements (SCE) and three (3) corresponding audio object channels 103 are illustrated in FIG. 1, a number M different from three (3) can obviously be implemented. The front pre-processing operation 155 produces ISM pre-processing parameters including, for example, time-domain transient detection, spectral analysis, long-term prediction analysis, pitch tracking and voicing analysis, voice/sound activity detection (VAD/SAD), band-width detection, and noise estimation for performing signal classification (coder type selection, signal classification, speech/music classification) for example as described in Reference [1].

The classification information, for example the VAD or local VAD flag as defined in EVS (Reference [1]) and/or the coder type from the front pre-processor 105 is passed to an ISM classifier 106 of the ISM format encoder 104 performing an ISM classification operation 156 of the ISM format encoding operation 154. The ISM classifier 106 receives classification information from the front pre-processor 105 and further classifies the individual audio object channels 107 according to their importance, using for example a method based on the method from Reference [3] and that will be further described in the following description. This classification information serves as a basis for the bit-rates adaptation algorithm (see Reference [3]) that distributes the available bit-budget among all the M audio object channels 108 (audio streams without metadata) from the ISM classifier 106 using the core-encoder configurator 109 of the ISM format encoder 104 performing a core-encoder configuration operation 159 of the ISM format encoding operation 154. The available bit-budget for coding the audio streams is then the bit-budget corresponding to the ism_total_brate bit-rate minus the ism_metadata_brate bit-rate for coding the metadata associated to the N audio object channels, and the ism_signaling_brate bit-rate for coding the ISM signaling. As described herein above, the ism_total_brate bit-rate 110 is set in the OMASA configurator 101. The core-encoder configurator 109 further sets high-level parameters of the core-encoders of the core-encoder section (see 111), for example the internal sampling rate or coded audio band-width based on the actual available bit-rate corresponding to ism_total_brate.

When the core-encoder configuration and bit-rate distribution between the audio object channels 108 (audio streams without metadata) is done, the ISM format encoding operation 154 continues with a sequential further pre-processing (further classification, core selection, other resampling, . . . ) and core-encoding operation 161 of the ISM format encoding operation 154 performed by a pre-processor and core-encoder 111 of the ISM format encoder 104. The further pre-processing (operation 161) of the M audio object channels 112 (audio streams without metadata) from the core-encoder configurator 109 is described for example in References [1] and [3]. Finally, the pre-processor and core-encoder 111 comprises a core-encoder section including a number M of individual fluctuating bit-rate mono core-encoders to sequentially encode all the M audio object channels 112 (audio streams without metadata) and the core-encoder indices are sent to the bit-stream writer 113 performing the bit-stream writing operation 163 where the resulting bit-stream from the bit-stream writer 113 is transmitted to the distant combined format decoder through the transmitter and communication channel (not shown).

The combined format encoder 100 comprises a MASA format encoder 115 performing a MASA format encoding operation 165 of the combined format encoding method 150.

In turn, the MASA format encoder 115 comprises a front pre-processor 116 performing a front pre-processing operation 166 of the MASA format encoding operation 165, a core-encoder configurator 117 performing a core-encoder configuration operation 167 of the MASA format encoding operation 165, and a pre-processor and core-encoder 118 performing a further pre-processing (further classification, core selection, other resampling, . . . ) and core-encoding operation 168 of the MASA format encoding operation 165.

By default, the stereo-MASA audio channels 119 (audio streams without metadata) from the OMASA analyser and ISM/MASA metadata coder 102 are coded using the channel pair element (CPE) MASA format encoder 115. The MASA format encoder 115 starts, similarly to the ISM format encoder 104, with the front pre-processing operation 166 to produce MASA pre-processing parameters. Next, the core-encoder configurator 117 receives the information about the masa_total_brate bit-rate 129 from the OMASA configurator 101 and sets the high-level core-encoder parameters. Finally, the further pre-processing and core-encoding operation 168 is performed on the two MASA audio channels 120 (audio streams without metadata) and the core-encoder indices are sent to the bit-stream writer 113 performing the bit-stream writing operation 163 where the resulting bit-stream from the bit-stream writer 113 is transmitted to the distant combined format decoder through the transmitter and communication channel (not shown).

It should be pointed out that, in the described illustrative implementation, the front pre-processor 116 is similar to the front pre-processor 105, the core-encoder configurator 117 is similar to the core-encoder configurator 109, and the pre-processor and core-encoder 118 is similar to the pre-processor and core-encoder 111.

Although this is not shown in the drawings, the ISM signaling coded using the ism_signaling_brate bit-rate and the MASA signaling coded using a masa_signaling_brate bit-rate are transferred to the writer 113 for insertion into the bit-stream and transmission to the distant combined format decoder. Obviously, the masa_metadata_brate bit-rate for coding the metadata in the OMASA analyser and MASA metadata coder 102 and the masa_signaling_brate bit-rate form part of the masa_total_brate bit-rate. Similarly, the ism_metadata_brate bit-rate for coding the ISM metadata and the ism_signaling_brate bit-rate form part of the ism_total_brate bit-rate.

### 2. FLEXIBLE COMBINED FORMAT BIT-RATE ADAPTATION

Coding the audio objects and MASA in OMASA combined format at constant bit-rates masa_total_brate and ism_total_brate is usually not the most efficient way of distributing the available ivas_total_brate bit-rate. In a typical scenario, an audio scene (e.g. ambience or the main speaker) is coded by MASA while additional individual speakers are coded as separate audio objects. When one of the speakers does not talk, the bit-rate associated to this speaker can be lowered or set to zero and the saved bit-budget can be transferred for coding the active speaker voice or the ambience.

The present disclosure thus extends the combined format encoding method of Reference [3] and makes the masa_total_brate and ism_total_brate bit-rates at one ivas_total_brate bit-rate in the combined format coding variable. This approach thus makes the codec framework more flexible, adaptive, and efficient.

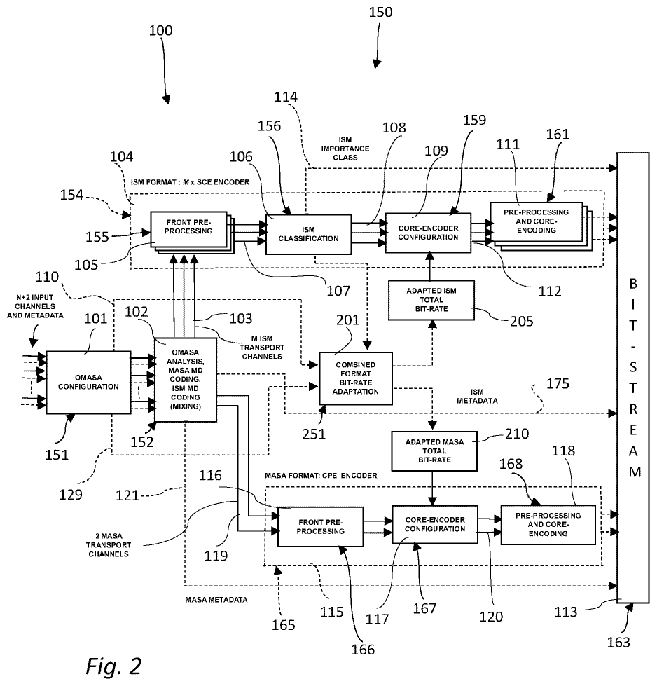

Referring to FIG. 2, the present disclosure thus introduces in the combined format encoder 100 a combined format bit-rate adaptation device 201 performing a combined format bit-rate adaptation operation 251 (forming part of the combined format encoding method 150).

Still referring to FIG. 2, the combined format bit-rate adaptation device 201 receives the information about classification of the M audio object channels 107 (for example one parameter per audio object channel); as described above, the ISM classification of the M audio object channels 107 is based on ISM pre-processing parameters from the front pre-processing operation 155. In the combined format bit-rate adaptation device 201, the nominal (initial) bit-rates of audio object channels are adapted based on the classification information and results in a variable, adapted bit-rate ism_total_brate. Consequently, the adapted masa_total_brate bit-rate varies accordingly.

In the following, the present disclosure considers that the number M of separately coded audio object channels 103 is equal to the number N of input audio object channels, i.e. M=N, but the disclosed algorithm is general such that M can be lower than N without deviating from the disclosed logic.

As stated in the foregoing description, the classification in the ISM classifier 106 can be done using for example the method from Reference [3]. Alternatively, the ISM classification can be based on one or more other front pre-processing parameters. An example of such alternative is a combination of the coder type parameter and the long-term noise as described in Reference [1].

Therefore, the ISM classification can be based on several parameters and/or combination thereof, for example coder type (coder_type), VAD, Forward Erasure Concealment (FEC) signal classification (class), speech/music classification decision, long-term Signal-to-Noise ratio (SNR) estimate from the open-loop ACELP/TCX core decision module (snr_celp, snr_tcx) of Reference [1], etc. In a non-restrictive example, a simple ISM classification based on the coder type as defined in Reference [3] is implemented. Consequently, the ISM classifier 106 rates the importance of the audio object channels 107 into the core-encoder configurator 109. As a result, four (4) distinct ISM importance classes, class_{ISM}, are defined:

$$Inactive class , ISM\_INACTIVE : e . g . frames where VAD = 0 \qquad ( a )$$

$$Low importance class , ISM\_LOW \_IMP : \\ frames where coder\_type = UNVOICED or INACTIVE \qquad ( b )$$

$$Medium importance class , ISM\_MEDIUM \_IMP : \\ frames where coder\_type = VOICED \qquad ( c )$$

$$High importance class , ISM\_HIGH \_IMP : \\ frames where coder\_type = GENERIC \qquad ( d )$$

An output from the ISM classifier 106 is thus an ISM importance flag (one per audio object channel) which further serves as a driving parameter for setting the bit-rates for all audio object channels, ism_brate(n), n=1, 2, . . . , N, and MASA, ism_masa_brate, in the combined format bit-rate adaptation device 201. It should be pointed out that the combined format bit-rate adaptation (operation 251) in the present disclosure is different from the teaching of Reference [3] in that the final ISM total bit-rate ism_total_brate usually varies from frame to frame and it is thus variable according to the present disclosure.

The ISM importance class, class_{ISM}, is transmitted from the ISM classifier 106 to the bit-stream writer 113 through line 114 where it is written in the bit-stream and transmitted therewith to the distant decoder where it serves as a driving parameter for setting the bit-rates for all audio object channels, ism_brate(n), and MASA, ism_masa_brate. Thus, the same combined format bit-rate adaptation algorithm is used both at the encoder 100 and distant decoder.

In general, the combined format bit-rate adaptation device 201 uses the following combined format bit-rate adaptation logic to assign a higher bit-rate to audio object channels with a higher importance and a lower bit-rate to audio object channels with a lower importance:
(1) Set initial ism_brate(n) bit-rates for all N audio object channels as the initial ism_total_brate bit-rate, divided by the number N of audio object channels, i.e.

$$ism\_brate ( n ) = ( ism\_total \_brate ) / N for n = 1 , … , N \qquad ( 3 )$$

while the initial ism_total_brate bit-rate 110 is set in the OMASA configurator 101, it is constant at one ivas_total_brate bit-rate and it represents a ‘nominal’ bit-rate around which the adapted ISM total bit-rate, ism_total_brate_{new}, 205 fluctuates.
(2) class_{ISM}=ISM_INACTIVE frames: a constant low bit-rate B_{VAD0} is assigned as ism_brate(n) bit-rate to an audio object channel n in this class. For example, the low bit-rate B_{VAD0} may correspond to a low-rate core-coder mode within IVAS which encodes the audio at 2.45 kbps.
(3) class_{ISM}=ISM_LOW_IMP frames: the initial ism_brate(n) for an audio object channel n in this class is adapted using the following relation (4):

$${ism\_brate}_{n e w} ( n ) = {γ}_{l o w} * ism\_brate ( n ) ) \qquad ( 4 )$$

where the weighting constant γ_{low} is usually set to a value lower than 1.0, for example to the value 0.8.
(4) class_{ISM}=ISM_MEDIUM_IMP frames: the initial ism_brate(n) for an audio object channel n in this class is adapted using the following relation (5):

$${ism\_brate}_{n e w} ( n ) = {γ}_{m e d} * ism\_brate ( n ) \qquad ( 5 )$$

where the weighting constant γ_{med} is set to a value higher than γ_{low}, for example to the value 1.0.
(5) class_{ISM}=ISM_HIGH_IMP frames: the initial ism_brate(n) for an audio object channel n in this class is adapted using the following relation (6):

$${ism\_brate}_{n e w} ( n ) = {γ}_{h i g h} * ism\_brate ( n ) \qquad ( 6 )$$

where the weighting constant γ_{high} is usually set to a value higher than 1.0 (higher than γ_{med}), for example to the value 1.4.
(6) The adapted bit-rate ism_brate_{new}(n) is checked against the minimum and the maximum threshold supported by the codec for a particular configuration (it is dependent for example on the core-encoder internal sampling rate, coded audio band-width, etc.).
(7) Repeat the steps (2) to (6) for every audio object channels n, n=1, . . . , N.

After the adapted ism_brate_{new}(n) bit-rates are computed for all N audio object channels, the combined format bit-rate adaptation device 201 computes the adapted ISM total bit-rate ism_total_brate_{new} 205 using the following relation (7):

$$ism\_total {\_brate}_{n e w} = {\sum }_{n = 1}^{n = N} {ism\_brate}_{n e w} ( n ) \qquad ( 7 )$$

Next, the core-encoder configurator 109 sets parameters of the core-encoders of the core-encoder section (see 111). For example, the internal sampling rate or coded audio band-width of the respective core-encoders are set based on the initial ism_brate(n) bit-rates. On the other hand, the adapted individual ism_brate(n) new bit-rates, from the device 201 for combined format bit-rate adaptation, are used by the core-encoder configurator 109 to specify the individual bit-rates attributed to the respective core-encoders of the core-encoder section (see 111) for coding the different audio object channels (without metadata and signaling bits). The individual adapted ism_brate(n)_{new} bit-rates are driving parameters for setting other core-encoder parameters of the core-encoders of the core-encoder section (see 111), for example the core mode (e.g. ACELP or TCX), coder type, BWE bitrate etc.

Finally, in the combined format bit-rate adaptation device 201, the adapted MASA total bit-rate masa_total_brate new 210 is computed using the following relation (8)

$$masa\_total {\_brate}_{n e w} = ivas\_total \_brate - ism\_total {\_brate}_{n e w} \qquad ( 8 )$$

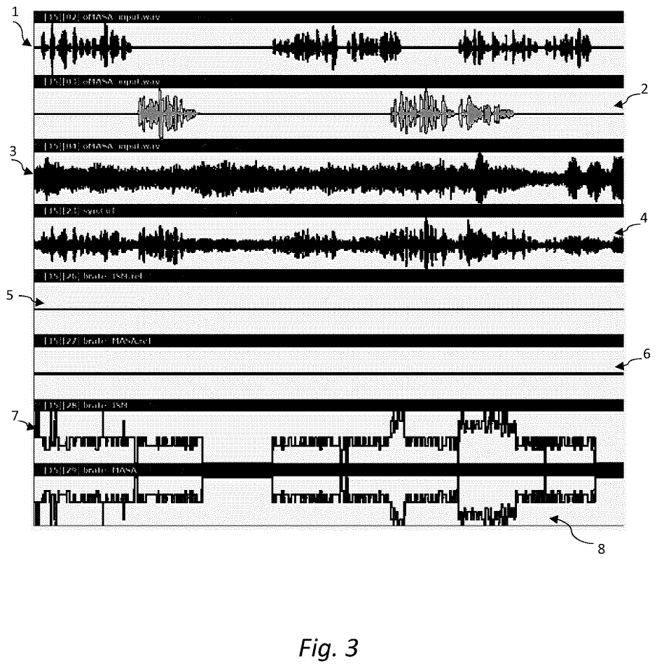

An example of the variable combined format bit-rate adaptation (operation 251) in the OMASA format coding is shown in FIG. 3. A combination of 2 audio objects and MASA formats coded at 80 kbps was used in this example. From the top of the figure, there are shown a first input audio object 1, a second input audio object 2, an input audio MASA 3, an output sound (binaural output) 4, a reference ism_total_brate 5, a reference masa_total_brate 6, a new (adapted) ism_total_brate 7, and a new (adapted) masa_total_brate 8, where ‘reference’ corresponds to a codec variant without the herein disclosed combined format bit-rate adaptation and ‘new’ corresponds to a codec variant where the herein disclosed combined format bit-rate adaptation is a part thereof.

It can be seen from the FIG. 3 that:
(a) in the reference variant (see 5 and 6 in FIG. 3), the ism_total_brate bit-rate (5) is constant at 32 kbps and the masa_total_brate bit-rate (6) is constant at 48 kbps,
(b) in the new variant (see 7 and 8 in FIG. 3 using the combined format bit-rate adaptation), the ism_total_brate bit-rate (7) is variable and it fluctuates between 4.9 kbps and 44.8 kbps and the masa_total_brate bit-rate (8) is similarly variable and it fluctuates between 35.2 kbps and 75.1 kbps.

### 3. FLEXIBLE COMBINED FORMAT BIT-RATE ADAPTATION VARIANTS

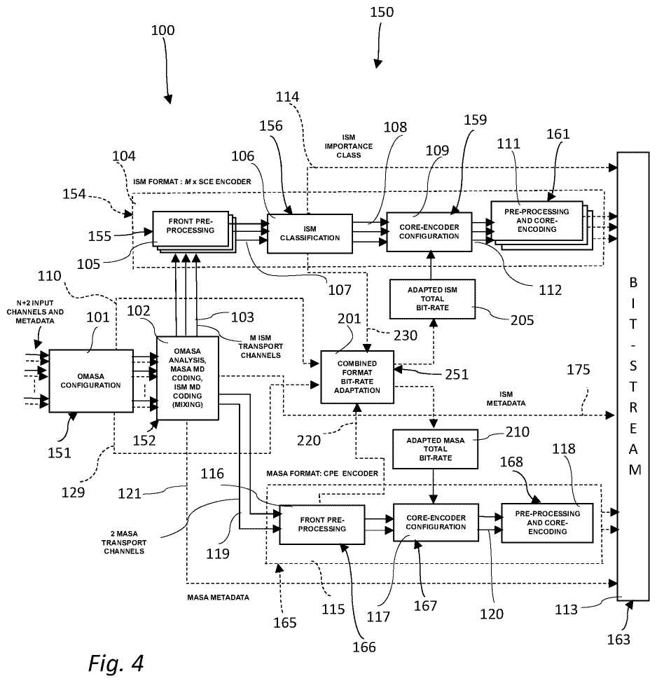

The schematic block diagram of FIG. 2 supposes that that the combined format bit-rate adaptation logic (device 201) depends on the ISM importance classification from ISM classifier 106. It is noted that the combined format bit-rate adaptation logic can similarly depend on a classification from other format parameters or from format parameters from both pre-processors 105 and 116. An example of the combined format bit-rate adaptation logic that depends on the parameters from both the ISM and MASA front pre-processors 105 and 116 is shown in FIG. 4.

In FIG. 4, an example of the MASA parameter that can be employed in the combined format bit-rate adaptation logic (device 201) is the low-pass filtered (LP) long-term (LT) noise energy value, Ipₙₒᵢₛₑ, 220 from the MASA front pre-processor 116. The idea is based on an assumption that an audio object can be coded using the low bit-rate core-coder mode within IVAS which encodes the audio at 2.45 kbps when the LT noise energy of the MASA audio channels (i.e. the scene ambience or the main speaker), Ipₙₒᵢₛₑ(MASA), is high compared to the LT noise energy value of an audio object channel, Ipₙₒᵢₛₑ(ISM(n)). Thus, a difference between the Ipₙₒᵢₛₑ(MASA) 220 of the scene ambience coded by MASA and Ipₙₒᵢₛₑ(ISM(n)) 230 of the audio object is computed and compared to a threshold. In other words, an audio object channel will be coded in the low bit-rate core-coder mode if its background noise would be ‘masked’ by the scene ambience audio. Consequently, in this example, the combined format bit-rate adaptation (operation 251) depends both on the front pre-processor 105 of the ISM format encoder 104 and the front pre-processor 116 of the MASA format encoder 115.

Thus, the ISM classification is different from the previous description and the inactive class ISM_INACTIVE is set under the condition of relation (9):

$$If ( {lp}_{noise} ( MASA ) - {lp}_{noise} ( ISM ( n ) ) \geq δ ) \\ then {class}_{ISM} = ISM\_INACTIVE \qquad ( 9 )$$

Relation (9) is applied in a loop for all N audio objects where δ is the above mentioned threshold, for example δ=30. It is noted that the processing in the ISM format encoder 104 and the MASA format encoder 115 is performed sequentially and that the parameters of the current frame for the ISM and MASA format may not be available when performing the combined format bit-rate adaptation operation 251. In order to get around of this limitation, parameters from a previous frame can be used instead. For example the Ipₙₒᵢₛₑ(ISM(n)) values from the current frame and the Ipₙₒᵢₛₑ(MASA) value from a previous frame can be used in relation (9).

In the previous description, the ISM classification was considered independent of the ism_total_brate bit-rate. However, in another example, it is advantageous to alter the classification at the higher initial (non-adapted) ism_total_brate bit-rates where the bit-rates per audio object and MASA are all sufficiently high. For example, the ISM_INACTIVE class and corresponding low bit-rate coding at B_{VAD0} are not used at higher bit-rates, for example in the case of IVAS when the initial bit-rate ism_brate(n)>48 kbps.

According to another example, the ISM classification (operation 156) of the audio object channels into one of a plurality of ISM importance classes may be altered as a function of the number of audio object channels that are separately coded and the initial ISM ism_total_brate bit-rate. For that purpose, the device for combined format bit-rate adaptation 201 (a) sets initial bit-rates ism_brate(n) for the audio objects channels as described above, (b) adapts the initial bit-rates by multiplying these initial bit-rates ism_brate(n) by weighting constants respectively associated to respective ones of the ISM importance classes as described above, and (c) alters the weighting constants γ_{low}, γ_{med}, and γ_{high} as a function of the number N of audio object channels that are separately coded and the initial ISM bitrate ism_brate(n) by audio object channel.

Similarly, in a further example, it is not necessary to employ the low-rate core-coder mode at the higher ism_total_brate bit-rates. Thus, for example, the ISM importance class_{ISM} ISM_INACTIVE is omitted in these cases and class_{ISM} ISM_LOW_IMP is used instead.

### 4. COMBINED FORMAT DECODER

The combined format decoder (not shown) receives the bit-stream from the bit-stream writer 113 that contains usually indices related to several codec modules, including audio format signaling, ISM or audio object transport channels (M×SCE indices), ISM metadata, MASA transport audio channel(s) (SCE or CPE indices), MASA metadata, and combined format signaling. First, the decoder reads and decodes from the received bit-stream information about the audio format. In case of a combined format, the decoder next reads the information needed to set the individual format bit-rates including the number N of audio objects and the ISM importance class for every audio object channel.

In case of OMASA, the decoder thus reads the number N of audio objects and the ISM importance class (one parameter per audio object channel). These parameters are then used to perform the combined format bit-rate adaptation logic the same way as at the encoder. The output from this logic are ISM and MASA total bit-rate parameters ism_total_brate and masa_total_brate which are further used to configure the core-decoders for the ISM and MASA decoding. The core-decoders for ISM and MASA parts are then processed sequentially and they output N synthesis corresponding to N audio objects plus two MASA synthesis. Finally, these N+2 synthesis with the decoded ISM and MASA metadata are all fed to the renderer which produces the final spatial sound in a desired output audio format (e.g. binaural, multi-channel, etc.).

As an example of implementation, there is provided a combined format decoder (and corresponding combined format decoding method) for decoding of a first number N of audio object channels in ISM format and a second number ‘+2’ of MASA audio transport channels. The combined format decoder (not shown) comprises:
a receiver of a bit-stream;
a bit-stream decoder for decoding from the bit-stream information about a codec total bit-rate, information about the codec format (e. OMASA format within IVAS), information about the first number N of ISM audio object channels, ISM audio channels coding information, MASA audio channels coding information, and information about an ISM importance class for each audio object channel;
a device for combined format bit-rate adaptation using the first number N of ISM audio objects channels, the codec total bit-rate ivas_total_brate, and the ISM importance class for each audio object channel for producing an adapted ISM total bit-rate ism_total_brate_{new} and adapted an MASA total bit-rate masa_total_brate_{new};
an ISM core-decoder for decoding the audio object channels in response to the ISM audio channel coding information from the bit-stream and a configurator of the ISM core-decoder in response to the adapted ISM total bit-rate ism_total_brate_{new}; and
a MASA core-decoder for decoding the MASA audio channels in response to the MASA audio channels coding information from the bit-stream and a configurator of the MASA core-decoder in response to the adapted MASA total bit-rate masa_total_brate_{new}.

### 5. EXAMPLE CONFIGURATION OF HARDWARE COMPONENTS

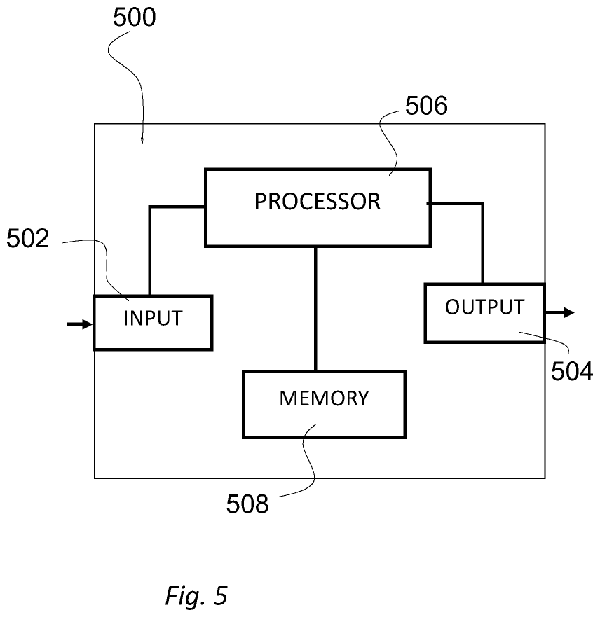

FIG. 5 is a simplified block diagram of an example configuration of hardware components forming the above-described combined format encoder 100 using the device for combined format bit-rate adaptation, the combined format encoding method 150 using the combined format bit-rate adaptation, the combined format decoder, and the combined format decoding method (herein after “combined format encoder/decoder and encoding/decoding method”).

The combined format encoder/decoder and encoding/decoding method may be implemented as a part of a mobile terminal, as a part of a portable media player, or in any similar device. The combined format encoder/decoder (identified as 500 in FIG. 5) comprises an input 502, an output 504, a processor 506 and a memory 508.

The input 502 is configured to receive the input signal information. The output 504 is configured to supply the output signal information. The input 502 and the output 504 may be implemented in a common module, for example a serial input/output device.

The processor 506 is operatively connected to the input 502, to the output 504, and to the memory 508. The processor 506 is realized as one or more processors for executing code instructions in support of the functions of the various operations and elements of the above described combined format encoder/decoder and encoding/decoding method as shown in the accompanying figures and/or as described in the present disclosure.

The memory 508 may comprise a non-transient memory for storing code instructions executable by the processor 506, specifically, a processor-readable memory comprising/storing non-transitory instructions that, when executed, cause a processor to implement the operations and elements of the combined format encoder/decoder and encoding/decoding method. The memory 508 may also comprise a random access memory or buffer(s) to store intermediate processing data from the various functions performed by the processor 508.

Those of ordinary skill in the art will realize that the description of the combined format encoder/decoder and encoding/decoding method are illustrative only and are not intended to be in any way limiting. Other embodiments will readily suggest themselves to such persons with ordinary skill in the art having the benefit of the present disclosure. Furthermore, the disclosed combined format encoder/decoder and encoding/decoding method may be customized to offer valuable solutions to existing needs and problems of encoding and decoding sound.

In the interest of clarity, not all of the routine features of the implementations of the combined format encoder/decoder and encoding/decoding method are shown and described. It will, of course, be appreciated that in the development of any such actual implementation of the combined format encoder/decoder and encoding/decoding method, numerous implementation-specific decisions may need to be made in order to achieve the developer's specific goals, such as compliance with application-, system-, network- and business-related constraints, and that these specific goals will vary from one implementation to another and from one developer to another. Moreover, it will be appreciated that a development effort might be complex and time-consuming, but would nevertheless be a routine undertaking of engineering for those of ordinary skill in the field of sound processing having the benefit of the present disclosure.

In accordance with the present disclosure, the elements, processing operations, and/or data structures described herein may be implemented using various types of operating systems, computing platforms, network devices, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used. Where a method comprising a series of operations and sub-operations is implemented by a processor, computer or a machine and those operations and sub-operations may be stored as a series of non-transitory code instructions readable by the processor, computer or machine, they may be stored on a tangible and/or non-transient medium.

Processing operations and elements of the combined format encoder/decoder and encoding/decoding method as described herein may comprise software, firmware, hardware, or any combination(s) of software, firmware, or hardware suitable for the purposes described herein.

In the combined format encoder/decoder and encoding/decoding method, the various processing operations and sub-operations may be performed in various orders and some of the processing operations and sub-operations may be optional.

Although the present disclosure has been described hereinabove by way of non-restrictive, illustrative embodiments thereof, these embodiments may be modified at will within the scope of the appended claims without departing from the spirit and nature of the present disclosure.

### 7. REFERENCES

The present disclosure mentions the following references, of which the full content is incorporated herein by reference:
[1] 3GPP TS 26.445, v.17.0.0, “Codec for Enhanced Voice Services (EVS); Detailed Algorithmic Description”, April 2022.
[2] 3GPP SA4 contribution S4-170749, “New WID on EVS Codec Extension for Immersive Voice and Audio Services”, SA4 meeting #94, Jun. 26-30, 2017, http://www.3gpp.org/ftp/tsg_sa/WG4_CODEC/TSGS4_94/Docs/S4-170749.zip
[3] V. Eksler, “Method and System for Coding Metadata in Audio Streams and for Efficient Bitrate Allocation to Audio Streams Coding,” U.S. patent application Ser. No. 17/596,567 filed on Dec. 13, 2021 and published under No. US20220319524 A1.
[4] 3GPP SA4 contribution S4-180462, “On spatial metadata for IVAS spatial audio input format”, SA4 meeting #98, Apr. 9-13, 2018, https://www.3gpp.org/ftp/tsg_sa/WG4_CODEC/TSGS4_98/Docs/S4-180462.zip
[5] 3GPP SA4 contribution S4-220443, “MASA format updates”, SA4 meeting #118-e, Apr. 6-14, 2022, https://www.3gpp.org/ftp/tsg_sa/WG4_CODEC/TSGS4_118-e/Docs/S4-220443.zip

### 8. SOURCE CODE

The ISM classification algorithm used by the ISM classifier 106 can be implemented using, for example, the following pseudo-code:

/*--------------------------------------------------------------*
* set_ism_importance_interformat ( )
*
* Set the importance of particular ISM streams in combined-format
coding
*--------------------------------------------------------------*/
void set_ism_importance_interformat(

| | |
|---|---|
| const int32_t ism_total_brate, | /* i/o: ISms total bitrate |

*/

| | |
|---|---|
| const int16_t nchan_transport, | /* i : number of transported |

channels
*/

| | |
|---|---|
| ISM METADATA_HANDLE hIsmMeta[ ], | /* i/o: ISM metadata handles |

*/

| | |
|---|---|
| SCE_ENC_HANDLE hSCE[], | /* i/o: SCE encoder handles |

* /

| | |
|---|---|
| const float lp_noise_CPE, | /* i : LP filtered total noise |

estimation */

| | |
|---|---|
| int16_t ism_imp[ ] | /* o : ISM importance flags |

```
* /
)
{
    Encoder_State *stm;
    int16_t ch, ctype, active_flag;
    for ( ch = 0; ch < nchan_transport; ch++ )
    {
      st = hSCE[ch] ->hCoreCoder[0];
      active_flag = st->vad_flag;
      if ( active_flag == 0 )
      {
        if ( st->1p_noise > 15 | | lp_noise_CPE - st->lp_noise < 30
        {
          active_flag = 1;
        }
      }
      /* do not use the low-rate core-coder mode at highest bit-
rates */
      if ( ism_total_brate / nchan_transport > IVAS_48k )
      {
        active_flag = 1;
      }
      ctype = hSCE[ch] - >hCoreCoder[0] ->coder_type_raw;
      st->low_rate_mode = 0;
      if ( active_flag == 0 )
      {
          ism_imp[ch] = ISM_INACTIVE_IMP;
          st->low_rate_mode = 1;
      }
      else if ( ctype == INACTIVE | | ctype == UNVOICED )
      {
          ism_imp[ch] = ISM_LOW_IMP;
      }
      else if ( ctype == VOICED )
      {
          ism_imp[ch] = ISM_MEDIUM_IMP;
      }
      else /* GENERIC */
      {
          ism_imp[ch] = ISM_HIGH_IMP;
      }
      hIsmMeta[ch]->ism_metadata_flag = active_flag; /* flag is
needed for the MD coding */
    }
    return;
}
```

The algorithm for the combined format bit-rate adaptation in an audio codec, that adapts the bit-rate of the audio object channels, can be implemented using, for example, the following pseudo-code:

/*--------------------------------------------------------------
* ivas_interformat_brate( )
*
* Bit-budget distribution in case of combined-format coding
*---------------------------------------------------------------*/

| | |
|---|---|
| #define GAMMA_ISM_LOW_IMP | 0.8f |
| #define GAMMA_ISM_MEDIUM_IMP | 1.0f |
| #define GAMMA_ISM_HIGH_IMP | 1.4f |

/ *! r: adjusted bitrate */
int32_t ivas_interformat_brate(

| | | |
|---|---|---|
| const int32_t element_brate, | /* i : element bitrate | */ |
| const int16_t ism_imp | /* i : ISM importance flag | */ |

```
)
{
  int32_t element_brate_out;
  int16_t nBits, limit_low, limit_high;
  nBits = (int16_t) ( element_brate / FRAMES_PER_SEC );
  if ( ism_imp == ISM_INACTIVE_IMP)
  {
  nBits = BITS_ISM_INACTIVE;
  }
  else if ( ism_imp == ISM_LOW_IMP )
  {
  nBits = (int16_t) ( nBits * GAMMA_ISM_LOW_IMP ) ;
  }
  else if ( ism_imp == ISM_MEDIUM_IMP
  )
  {
  nBits = (int16_t) ( nBits * GAMMA_ISM_MEDIUM_IMP ) ;
  }
  else /* ISM_HIGH_IMP */
  {
  nBits = (int16_t) ( nBits * GAMMA_ISM_HIGH_IMP );
  }
  limit_low = MIN_BRATE_SWB_BWE / FRAMES_PER_SEC;
  if ( ism_imp == ISM_INACTIVE_IMP
  {
  limit_low = BITS_ISM_INACTIVE;
  }
  else if ( element brate >= SCE CORE 16k LOW LIMIT
  )
  {
  limit_low = SCE_CORE_16k_LOW_LIMIT / FRAMES_PER_SEC;
  }
  limit_high = IVAS_512k / FRAMES_PER_SEC;
  if ( element_brate < SCE_CORE_16k_LOW_LIMIT
  {
  limit_high = ACELP_12k8_HIGH_LIMIT / FRMS_PER_SECOND;
  }
  nBits = check_bounds_s( nBits, limit_low, limit_high );
  element_brate_out = nBits *FRAMES_PER_SEC;
  return element_brate_out;
}
```

1-50. (canceled)

51. A combined format encoder for coding a number of first audio object channels in ISM format and a number of second audio channels in immersive audio (IA) format, comprising:
at least one processor; and
a memory coupled to the processor and storing non-transitory instructions that when executed cause the processor to implement:
an ISM format encoder comprising:
a first front pre-processor of the audio object channels to produce ISM pre-processing parameters; and
a first core-encoder section responsive to an adapted ISM total bit-rate for coding the audio object channels; and
an IA format encoder responsive to an adapted IA total bit-rate for coding the second audio channels; and
a device for combined format bit-rate adaptation using at least one ISM pre-processing parameter from the first front pre-processor for (a) adapting an initial ISM total bit-rate to produce the adapted ISM total bit-rate and (b) adapting an initial IA total bit-rate to produce the adapted IA total bit-rate.

52. A combined format encoder according to claim 51, wherein the first core-encoder section comprises first core-encoders for coding the audio object channels and a configurator of the first core-encoders in response to the adapted ISM total bit-rate.

53. A combined format encoder according to claim 51, wherein the IA format encoder comprises:
a second front pre-processor of the second audio channels to produce IA pre-processing parameters;
a second core-encoder section responsive to the adapted IA total bit-rate for coding the second audio channels.

54. A combined format encoder according to claim 53, wherein the second core-encoder section comprises second core-encoders for coding the second audio channels and a configurator of the second core-encoders in response to the adapted IA total bit-rate.

55. A combined format encoder according to claim 53, wherein the device for combined format bit-rate adaptation uses:
at least one ISM pre-processing parameter from the first front pre-processor; or
at least one ISM pre-processing parameter from the first front pre-processor and at least one IA pre-processing parameter from the second front pre-processor,
for (a) adapting the initial ISM total bit-rate to produce the adapted ISM total bit-rate and (b) adapting the initial IA total bit-rate to produce the adapted IA total bit-rate.

56. A combined format encoder according to claim 51, wherein the non-transitory instructions stored in the memory cause, when executed, the processor to implement an ISM classifier of the audio object channels into one of a plurality of ISM importance classes using the at least one ISM pre-processing parameter from the first front pre-processor.

57. A combined format encoder according to claim 56, wherein the device for combined format bit-rate adaptation (a) sets initial bit-rates for coding the audio objects channels and (b) adapts a part of the initial bit-rates by multiplying these initial bit-rates by weighting constants respectively associated to respective ones of the ISM importance classes.

58. A combined format encoder according to claim 57, wherein the device for combined format bit-rate adaptation calculates the adapted ISM total bit-rate as a sum of the adapted bit-rates of the individual audio object channels including metadata of these individual audio object channels.

59. A combined format encoder according to claim 51, wherein the device for combined format bit-rate adaptation adapts the IA total bit-rate by subtracting the adapted ISM total bit-rate from a total codec bit-rate.

60. A combined format encoder according to claim 55, wherein the at least one ISM pre-processing parameter comprises a low-pass filtered long-term noise energy value of one of the audio object channels and/or the at least one IA pre-processing parameter comprises the low-pass filtered long-term noise energy value of the second audio channels.

61. A combined format encoder according to claim 55, wherein the at least one ISM pre-processing parameter or the at least one IA pre-processing parameter used in a current frame is a parameter from a previous frame.

62. A combined format encoder according to claim 57, wherein the ISM classifier of the audio object channels alters the classification as a function of the initial ISM total bit-rate, and wherein the weighting constants are dependent from the initial ISM total bit-rate.

63. A combined format encoder according to claim 51, wherein the non-transitory instructions stored in the memory cause, when executed, the processor to implement an ISM classifier of the audio object channels into one of a plurality of ISM importance classes, wherein the ISM classifier of the audio object channels alters the classification as a function of a number of audio object channels that are separately coded and an initial ISM bit-rate by audio object channel.

64. A combined format encoder according to claim 63, wherein the device for combined format bit-rate adaptation (a) sets initial bit-rates for coding the audio objects channels, (b) adapts the initial bit-rates by multiplying these initial bit-rates by weighting constants respectively associated to respective ones of the ISM importance classes, and (c) alters the weighting constants as a function of the number of audio object channels that are separately coded and the initial ISM bitrate by audio object channel.

65. A combined format encoder according to claim 51, wherein the immersive audio (IA) format is a MASA format.

66. A combined format method for encoding a number of first audio object channels in ISM format and a number of second audio channels in immersive audio (IA) format, comprising:
ISM format encoding the audio object channels comprising:
front pre-processing the audio object channels to produce ISM pre-processing parameters; and
core-encoding the audio object channels in response to an adapted ISM total bit-rate; and
IA format encoding the second audio channels in response to an adapted IA total bit-rate; and
a combined format bit-rate adaptation using at least one ISM pre-processing parameters from the front pre-processing of the audio object channels for (a) adapting an initial ISM total bit-rate to produce the adapted ISM total bit-rate and (b) adapting an initial IA total bit-rate to produce the adapted IA total bit-rate.

67. A combined format encoding method according to claim 66, wherein IA format encoding the second audio channels comprises:
front pre-processing the second audio channels to produce IA pre-processing parameters; and
core-encoding the second audio channels in response to the adapted IA total bit-rate.

68. A combined format encoding method according to claim 67, wherein the combined format bit-rate adaptation uses:
at least one ISM pre-processing parameter from the front pre-processing of the audio object channels; or
at least one ISM pre-processing parameter from the front pre-processing of the audio object channels and at least one IA pre-processing parameter from the front pre-processing of the second audio channels,
for (a) adapting the initial ISM total bit-rate to produce the adapted ISM total bit-rate and (b) adapting the initial IA total bit-rate to produce the adapted IA total bit-rate.

69. A combined format encoding method according to claim 66, further comprising:
classifying the audio object channels into one of a plurality of ISM importance classes.

70. A combined format encoding method according to claim 69, wherein the combined format bit-rate adaptation comprises (a) setting initial bit-rates for coding the audio objects channels and (b) adapting a part of the initial bit-rates by multiplying these initial bit-rates by weighting constants respectively associated to respective ones of the ISM importance classes.

71. A combined format encoding method according to claim 66, wherein the combined format bit-rate adaptation adapts the IA total bit-rate by subtracting the adapted ISM total bit-rate from a total codec bit-rate.

72. A combined format encoding method according to claim 68, wherein the at least one ISM pre-processing parameter comprises a low-pass filtered long-term noise energy value of one of the audio object channels and/or the at least one IA pre-processing parameter comprises the low-pass filtered long-term noise energy value of the second audio channels.

73. A combined format encoding method according to claim 68, wherein the at least one ISM pre-processing parameter or the at least one IA pre-processing parameter used in a current frame is a parameter from a previous frame.

74. A combined format encoding method according to claim 66, further comprising:
classifying the audio object channels into one of a plurality of ISM importance classes, wherein the classification of the audio object channels comprises altering the classification as a function of a number of audio object channels that are separately coded and an initial ISM bit-rate by audio object channel.

75. A combined format encoding method according to claim 74, wherein the combined format bit-rate adaptation comprises (a) setting initial bit-rates for coding the audio objects channels, (b) adapting the initial bit-rates by multiplying these initial bit-rates by weighting constants respectively associated to respective ones of the ISM importance classes, and (c) altering the weighting constants as a function of the number of audio object channels that are separately coded and the initial ISM bitrate by audio object channel.

76. A combined format encoding method according to claim 66, wherein the immersive audio (IA) format is a MASA format.
